(19) United States
(12) Patent Application Publication
(10) Pub. No.: US 2007/0071229 A1
(43) Pub. Date: Mar. 29, 2007

(54) Method and communication arrangement for the detection of at least one additional communication device which can be connected to at least one subscriber line

(76) Inventors: Werner Kozek, Wien (AT); Peter Rupprich, Wien (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/571,745

(22) PCT Filed: Aug. 5, 2004
(86) PCT No.: PCT/EP04/51727

§ 371 Date: Mar. 14, 2006

(30) Foreign Application Priority Data
Sep. 16, 2003 (DE) 10342806.2

(51) Int. Cl. H04M 1/00; H04M 9/00

(52) U.S. Cl. 379/399.01

(57) ABSTRACT

A method and a communication system for the detection of at least one other communication device which can be connected to at least one subscriber connection line is provided. The transmission function of the at least one subscriber connection line is monitored with respect to significant modifications in order to detect at least one additional communication device which can be connected to at least one subscriber connection line. The detection of at least one other communication device connected to the subscriber connection line is displayed if a significant modification of the transmission function is determined. Communication devices and/or listening devices having high input impedance connected to the subscriber connection line may be detected.

### CROSS REFERENCE TO RELATED APPLICATIONS

This application is the US National Stage of International Application No. PCT/EP2004/051727, filed Aug. 5, 2004 and claims the benefit thereof. The International Application claims the benefits of German application No. 10342806.2 DE filed Sep. 16, 2003, both of the applications are incorporated by reference herein in their entirety.

### FIELD OF INVENTION

The present invention relates to a method and communication arrangement for the detection of at least one additional communication device which can be connected to at least one subscriber line.

### BACKGROUND OF INVENTION

In current communication networks the subscribers or communication terminals assigned to the subscribers, such as network connection devices (NT Network Termination) for instance, are connected to central switching equipment or digital multiplexer devices (also known as DSLAM, Digital Subscriber Line Access Multiplexer) via subscriber lines. The subscriber-side communication terminals or the switching equipment are each connected to the respective subscriber lines, which can be configured for instance as two-wire or four-wire lines, via a subscriber line unit or via a modem arranged in the respective subscriber line unit, with the data communication between the modems being carried out via the subscriber lines by means of an xDSL transmission method for instance.

In particular where subscriber lines are concerned, the situation occurs where the information exchange between switching equipment and a communication terminal of the subscriber connected via the subscriber line is tapped by a further communication facility, also known as a monitoring device. This situation is also known as wire-tapping the subscriber line. By way of example, FIG. 1 shows a schematic representation of the typical wire-tapping of the subscriber line. According to FIG. 1, a communication device B on the subscriber side is connected to switching equipment A via a subscriber line TAL. Additionally, a further communication device C configured as a monitoring device is connected to the subscriber line TAL via a spur line SL. The monitoring device C is connected to the subscriber line TAL in such a manner that the monitoring device C can receive all information that is bidirectionally transmitted via the subscriber line TAL.

### SUMMARY OF INVENTION

The detection or recognition of monitoring devices of this type connected to the subscriber line plays an increasingly important role in terms of information security. Different methods are currently known, with the aid of which the wire-tapping of a subscriber line can be detected or prevented. The simplest method is to measure the direct current input resistance of the subscriber line. Each additional connection of a further communication terminal, such as a monitoring device on the subscriber line for instance, causes a change in the supply voltage and can thus be detected as a change in the direct current input resistance of the subscriber line. The use of monitoring devices featuring a high input impedance nevertheless makes detection methods of this type ineffective, e.g. by the use of probes with high input impedance, since these monitoring devices cannot be detected using measurements.

An object of the invention is to improve the detection of monitoring devices connected to a subscriber line and thus to ensure and guarantee a safe data transmission via the subscriber line. The connection of monitoring devices featuring a high input impedance to the subscriber line is also to be detected. The object is achieved by a method and by a communication arrangement according to the features of the independent claims.

The essential aspect of the method according to the invention for the detection of at least one further communication device which can be connected to at least one subscriber line is to monitor the transmission function of the at least one subscriber line in respect of significant changes, with the detection of the at least one further communication device connected to the subscriber line being indicated when a significant change in the transmission function is determined.

The essential advantage of the method according to the invention consists solely in detecting the connection of monitoring devices featuring a high input impedance to a subscriber line. Furthermore, with the aid of the method according to the invention, it is possible to monitor whether in addition to an envisaged number of communication devices connected to a subscriber line, further communication devices are optionally connected to the subscriber or subscriber line. Illegal intrusion of communication devices, e.g. illegal use of a subscriber line by third parties, can be detected in this way. The method according to the invention ensures a more secure data transmission between central switching equipment and communication terminals assigned to the respective subscribers.

According to an advantageous development of the method according to the invention, the transmission function of the subscriber line is detected in approximately periodic time intervals and an average of the transmission function is derived from the detection results. The deviation of the currently determined transmission function from the average of the transmission function is monitored, with the detection of the at least one further communication device being indicated when a deviation exceeding a predetermined threshold value is determined. The advantage of this development is thus that temporal changes in the transmission function of the subscriber line can be accounted for if necessary, thereby avoiding fault detections or fault alarms.

Further advantageous embodiments of the method according to the invention and a communication arrangement for detecting at least one further communication device which can be connected to the at least one subscriber line are set down in the dependent claims.

### BRIEF DESCRIPTION OF THE DRAWINGS

The method according to the invention is described in more detail below with reference to a number of drawings, wherein;

FIG. 1 shows a connection scenario with a monitoring device connected to a subscriber line

FIG. 2 shows the division of a transmission channel formed by the subscriber line in respect of the Shannon capacity for the purpose of the monitoring device

FIG. 3 shows the course of the method according to the invention in the form of a self-explanatory flow diagram

### DETAILED DESCRIPTION OF INVENTION

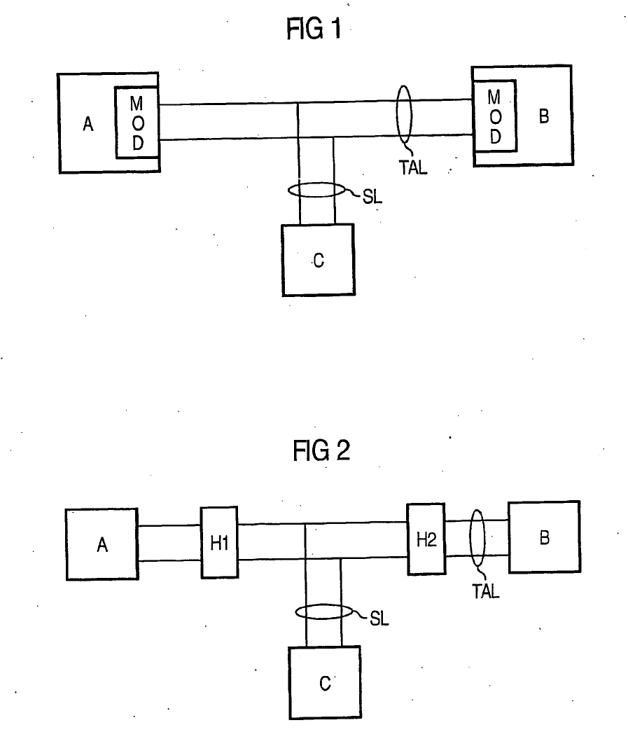

Reference is made again to the previously mentioned communication arrangement displayed in FIG. 1. In this exemplary embodiment the communication device represents central switching equipment or a multiplexer device to which a subscriber (not shown) is connected via a subscriber line TAL by means of a communication device B configured as a network termination device. The communication devices A, B are connected to the subscriber line TAL in each instance via an xDSL modem MOD. The principle of the method according to invention is that with a “clean” subscriber line, i.e. with a subscriber line without a monitoring device C connected thereto, as much line-specific information as possible, such as transmission function, background noise etc., is detected, maintained and stored for instance. A clean and/or non wire-tapped subscriber line—with at least two communication devices connected thereto and communicating with one another via this subscriber line—generally comprises strong, linear time-invariant characteristics, and can thus be characterized or identified by its transmission function H_{current} in the frequency range. The connection of a further communication device causes the plot of the input impedance of the subscriber line to change for instance, thereby resulting in a significant change in the transmission function H_{current}.

In accordance with the invention, the transmission function H_{current} of the subscriber line is monitored for significant changes, with a significant change in the transmission function H_{current} being indicated by means of an alarm. The use of the xDSL transmission method advantageously allows methods already conforming to standards for detecting the current transmission function H_{current} (e.g. within the scope of a training phase or prequalification phase) to be accessed. All current xDSL transmission methods (CAP, DMT, QAM, TH-PHM) start with a so-called training phase, wherein the transmission function H_{current} of the subscriber line is implicitly (equalization coefficients with QAM) or explicitly (with DMT) determined. Routines of this type are already implemented using hardware, i.e. in the form of chipsets in the individual connection units or modems. The method according to the invention can be implemented on both sides of the subscriber line TAL, e.g. by the xDSL modem arranged in the switching equipment A and/or by the xDSL modem arranged in the network termination device B.

The transmission function H_{current} can be detected both during the current information transmission via the subscriber line TAL and also for instance within the scope of the standardized training method according to ITU-T G.992.3—double ended loop test (DELT).

The currently detected transmission function H_{current} is typically stored in the form of frequency-dependent coefficients, with the stored information being cyclically called up within the scope of the method according to the invention and further processed.

Modem xDSL transmission systems operate near to the physical limits of the Shannon capacity applicable to the digital signal transmission.

$$R = Bld ( 1 + \frac{S}{N} ) ,$$

with
B representing the bandwidth
S/N representing the signal/noise ratio and
R representing the achievable bit transmission rate.

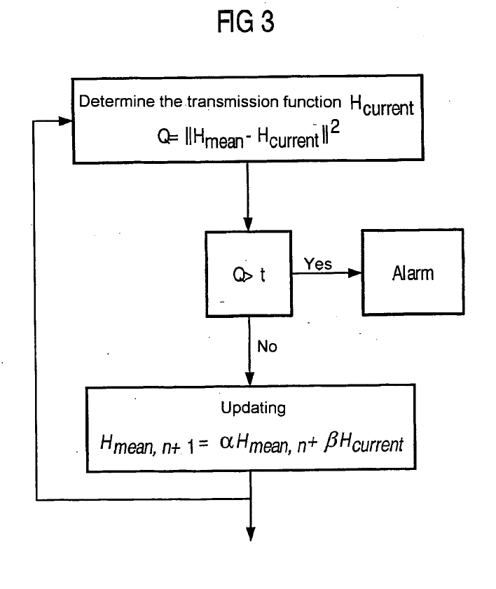

This Shannon theory cannot be obviated by wire-tapping the subscriber line TAL by means of a monitoring device. FIG. 2 shows the division of the transmission channel arranged between the communication units A and B in respect of the Shannon capacity for the purpose of the monitoring device C. Provided that a homogeneous subscriber line TAL is obvious, both for the case H₁→0 or H₂→0 (Hₓ corresponds to the transmission function of the relevant line segments of the subscriber line), an undetectable wire tap of the subscriber line is physically impossible, particularly in the event that the bandwidth of the data communication between A and B moves at the margin of the Shannon capacity. This means that with the use of an xDSL transmission method, the nearer the data communication between the relevant communication units moves to the Shannon capacity, the greater the information security.

Additional security with the detection of monitoring devices is achieved, if the bandwidth of the data communication via the subscriber line is extended with the aid of specific band pass signals (such as pilot tones or band pass pseudo noises for instance). An interceptor will normally not notice the frequency range outside the standardized communication bandwidth (e.g. 2.2 Mhz with ADSL transmission methods), so that the probability of detecting an interception attempt by characteristic echos in this extended bandwidth region is great. This improvement can be easily implemented, since currently commercially available modems are able to detect the transmission function even in this extended bandwidth region.

Changes to the characteristic transmission function H_{current} can also be effected by measuring processes exposed to noise. To prevent or contain the fault alarms caused in this manner, it is advantageous to determine the moving average of the measured transmission function Hₘₑₐₙ (average) as follows;
H_{mean,n+1}αH_{mean,n}+βH_{current}
with 0<α,β<1

The cost function Q for the display of monitoring devices connected to the subscriber line is defined as follows
Q=∥Hₘₑₐₙ−H_{current}∥²

The norm of the detected transmission function H is defined as L₂ norm according to

$${‖ H ‖}^{2} = {\sum }_{k = 0}^{N} {\vert H ( k ) \vert}^{2}$$

with N representing the number of subcarriers of the xDSL signal.

According to the self-explanatory flow diagram shown in FIG. 3, the detection of a monitoring device, i.e. the emission of an alarm based on a threshold value t, the condition

Q>t results in an alarm, and

Q<t only results in an update of the moving average of the detected transmission function Hₘₑₐₙ.

As already explained, the subscriber lines can be configured as two-wire or four-wire or N-wire lines. According to the invention, the L2 norm of the transmission function H is determined, as a function of the respective number of wire pairs per subscriber line Tal, as follows.

$${‖ H ‖}^{2} = {\sum }_{1 = 0}^{M} {\sum }_{k = 0}^{N} {\vert H ( k ) \vert}^{2}$$

with
M=representing the number of the line pairs per subscriber line (xDSL connection)
N=representing the number of the subcarriers of the xDSL signal.

With the aid of the method according to the invention, the wire-tapping of subscriber lines having an xDSL transmission method can be easily detected. Advantageously, already commercially available xDSL modems can be used for the realization of the method according to the invention, since within the scope of the standard conform training phase or prequalification method, these already comprise mechanisms for detecting the transmission function of subscriber lines, so that this information must only be further processed within the scope of the method according to the invention.

Novel possibilities and extremely high-ohmic wire taps by the field influence result particularly within the high frequency region, e.g. with VDSL transmission methods, (e.g. parasitic capacities for instance) and can be detected during the connection itself.

1.-9. (canceled)

10. A method for detecting a first communication device connected to a subscriber line, comprising:
examining a transmission function of the subscriber line for a deviation; and
indicating detecting the first communication device if the deviation exceeds a threshold value.

11. The method according to claim 10,
wherein a second and third communication device is connected to the subscriber line to transmit information between the second and third communication device,
wherein the transmission function of the first and/or second communication device is examined.

12. The method according to claim 11,
wherein the transmission function detects the subscriber line in approximately periodic time intervals and an average of the transmission function is derived from the detection results,
wherein the deviation of the transmission function from the average of the transmission function is examined, and
wherein the first communication device is detected when the deviation exceeds the threshold value.

13. The method according to claim 10,
wherein the transmission function detects the subscriber line in approximately periodic time intervals and an average of the transmission function is derived from the detection results,
wherein a deviation of the transmission function is examined by the average of the transmission function, and
wherein the first communication device is detected when a deviation exceeds a threshold value.

14. The method according to claim 13, wherein when the subscriber line comprises a plurality of wire pairs, the transmission function is examined per wire pair.

15. The method according to claim 14, wherein information is transmitted between the second and third communication device according to an xDSL transmission method.

16. The method according to claim 15, wherein the examining is carried out by an xDSL modem assigned to the first and/or second communication device.

17. The method according to claim 10, wherein when the subscriber line comprises a plurality of wire pairs, the transmission function is examined per wire pair.

18. The method according to claim 10, wherein when the first communication device is a monitoring device.

19. The method according to claim 11, wherein information is transmitted between the second and third communication device according to an xDSL transmission method.

20. The method according to claim 19, wherein the examining is carried out by an xDSL modem assigned to the first and/or second communication device.

21. A communication arrangement for the detection of a monitoring device that is connected to a subscriber line, comprising:
an examiner for examining the transmission function of the subscriber line for a deviation indicating the detection of the monitoring device; and
a display that indicates the detection of the monitoring device.

22. The communication arrangement according to claim 21, wherein a first and second communication device is connected to the subscriber line for transmitting information.
